(19) United States
(12) Patent Application Publication
(10) Pub. No.: US 2007/0259314 A1
(43) Pub. Date: Nov. 8, 2007

(54) Dental drill

(76) Inventors: Karl-Heinz Danger, Detmold (DE); Bernd Otto, Kalletal (DE)

Correspondence Address: BLISS MCGLYNN, P.C., 2075 WEST BIG BEAVER ROAD, SUITE 600, TROY, MI, 48084, US

(21) Appl. No.: 11/784,927

(22) Filed: Apr. 10, 2007

(30) Foreign Application Priority Data
Apr. 11, 2006 (DE) 20 2006 005 885.0

(51) Int. Cl. A61C 3/02

(52) U.S. Cl. 433/165

(57) ABSTRACT

A dental drill includes a shaft and a head extending from an end of the shaft. The head includes at least one cutting edge and defines a length of greater than about 2.5 mm.

### BACKGROUND OF THE INVENTION

1. Field of the Invention

The present invention relates, generally, to a dental drill and, in particular, to a dental drill for use in treating fissures (decayed areas) of teeth.

2. Description of the Related Art

A dental drill for use in treating decayed areas of teeth is disclosed in U.S. Pat. 6,257,889 B1, the disclosure of which is incorporated herein by reference. In such treatment, the operating depth of the dental drill is particularly relevant in removing the decay. More specifically, the dentist is interested in removing the decayed areas as exactly as possible and simultaneously preserving the non-decayed tooth substance. For this reason, it is particularly important that the operating depth of the dental drill be determined exactly.

The related art discloses relatively short dental drills each of which includes a head defining a length of, e.g., 1.5 mm or 2.5 mm. These head lengths, however, are often not sufficient for a complete treatment to be performed with a single dental drill such that the dentist has to exchange and use further dental drills to complete the treatment. As a result, the treatment is not optimized.

Thus, there remains a need in the related art for a dental drill use of which permits for an optimized treatment. More specifically, there remains a need in the related art for a dental drill use of which permits a relatively deep treatment to be performed completely such that exchange and use of further dental drills is not required to complete the treatment. There also remains a need in the related art for such a dental drill that has a simple structure. There also remains a need in the related art for such a dental drill that can be manufactured in a simple and cost-effective manner.

### SUMMARY OF THE INVENTION

The present invention overcomes the disadvantages in the related art in a dental drill. The dental drill includes a shaft and a head extending from an end of the shaft. The head includes at least one cutting edge and defines a length of greater than about 2.5 mm.

One advantage of the dental drill of the present invention is that use thereof permits for an optimized treatment.

Another advantage of the dental drill of the present invention is that use thereof permits a relatively deep treatment to be performed completely such that exchange and use of further dental drills is not required to complete the treatment.

Another advantage of the dental drill of the present invention is that it has a simple structure.

Another advantage of the dental drill of the present invention is that it can be manufactured in a simple and cost-effective manner.

Another advantage of the dental drill of the present invention is that it is universally usable.

Another advantage of the dental drill of the present invention is that use thereof permits an operating depth of the dental drill to be recognized without any problem.

Another advantage of the dental drill of the present invention is that use thereof permits a mark of depth of the dental drill to be optically visible.

Another advantage of the dental drill of the present invention is that use thereof permits the mark of depth of the dental drill to be clearly discernable during rotation of the dental drill.

Another advantage of the dental drill of the present invention is that it can be provided with more than one mark of depth each of which clearly indicates the operating depth of the dental drill.

Another advantage of the dental drill of the present invention is that mechanical strength of the head in not substantially affected.

Another advantage of the dental drill of the present invention is that the cutting edge(s) permit(s) the operating depth of the dental drill to be relatively greater to guarantee the treatment.

Other objects, features, and advantages of the present invention will be readily appreciated as the same becomes better understood while reading the subsequent description taken in conjunction with the accompanying drawings.

### BRIEF DESCRIPTION OF THE DRAWINGS

FIG. 1 is a side view of an embodiment of the dental drill of the present invention;

FIG. 2 is a front view of the embodiment of the dental drill of the present invention illustrated in FIG. 1;

FIG. 3 is a side view of another embodiment of the dental drill of the present invention;

FIG. 4 is a front view of the embodiment of the dental drill of the present invention illustrated in FIG. 3;

FIG. 5 is a side view of another embodiment of the dental drill of the present invention;

FIG. 6 is a front view of the embodiment of the dental drill of the present invention illustrated in FIG. 5;

FIG. 7 is a side view of another embodiment of the dental drill of the present invention;

FIG. 8 is a front view of the embodiment of the dental drill of the present invention illustrated in FIG. 7;

FIG. 9 is a schematic partial side view of another embodiment of the dental drill of the present invention;

FIG. 10 is a sectional view along line A-A of FIG. 9;

FIG. 11 is a schematic partial side view of another embodiment of the dental drill of the present invention; and

FIG. 12 is a sectional view along line A-A of FIG. 11.

### DETAILED DESCRIPTION OF EMBODIMENTS OF THE INVENTION

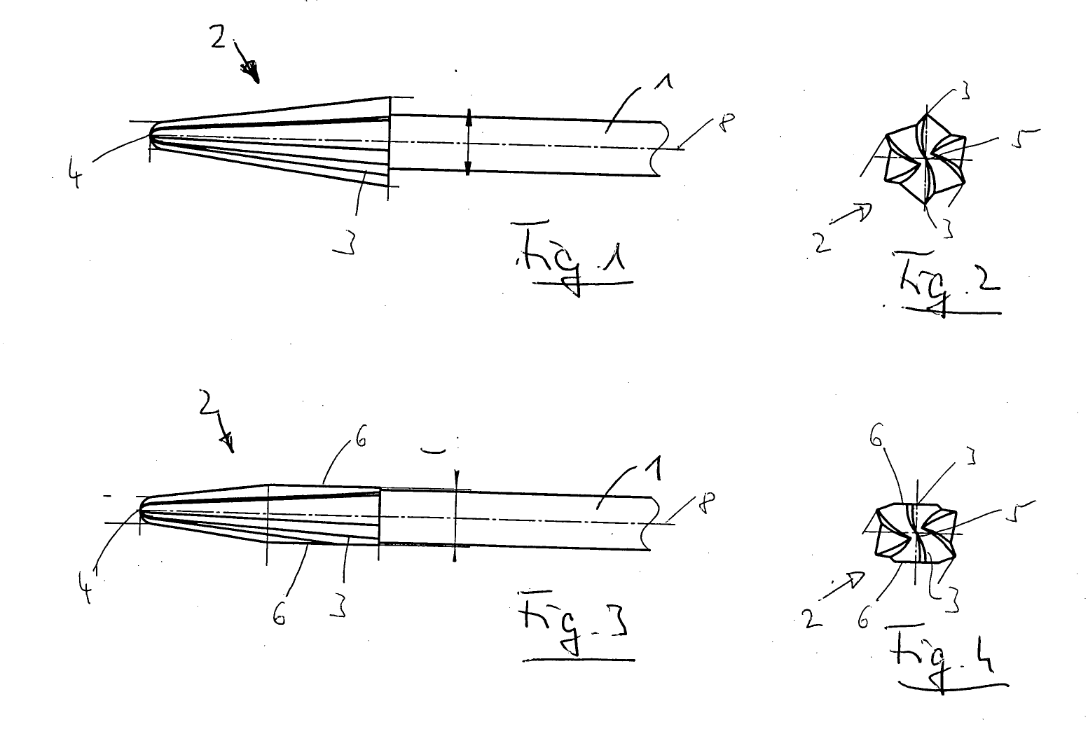

A dental drill according to the present invention is generally indicated at 10 in FIGS. 1 through 12, where like numerals are used to designate like structure throughout the figures. In general, the dental drill 10 includes a shaft, generally indicated at 12, and a head, generally indicated at 14, extending from an end of the shaft 12. The head 12 includes at least one cutting edge 16 and defines a length “L” of greater than about 2.5 mm.

More specifically and referring to FIGS. 1, 3, 5, 7, 9, and 11, the head 14 is substantially conical and integrally formed with the shaft 12. Also, the head 14 defines an arcuate tip 18. Preferably, the head 14 defines a length “L” of about 3.1 mm. Also preferably, the dental drill 10 includes a plurality of cutting edges 16. The cutting edges 16 are substantially straight or helical. Two cutting edges 16 together form a cross-cutting edge 20.

It should be appreciated by those having ordinary skill in the related art that each of the shaft 12 and head 14 can have any suitable shape, size, and structure and structural relationship with each other. It should be so appreciated also that each of the cutting edges 16 and tip 18 can have any suitable shape, size, and structure and structural relationship with each other and the remainder of the head 16.

In an embodiment of the dental drill 10 shown in FIGS. 3 and 4, at least one axial mark 22 is arranged at a portion of the head 14, in the form of an oblate portion of the head 14, substantially facing the shaft 12. More specifically, a pair of first axial marks 22 are provided opposite to each other with respect to a rotary axis “A” and form a plane disposed substantially parallel with the rotary axis “A.” The position of the first axial marks 22, in particular, is discernible in FIG. 4. One of the first axial marks 22 starts at a distance of, e.g., about 1.65 mm from the tip 18 of the head 14 and extends along a remaining length of the head 14 to the shaft 12.

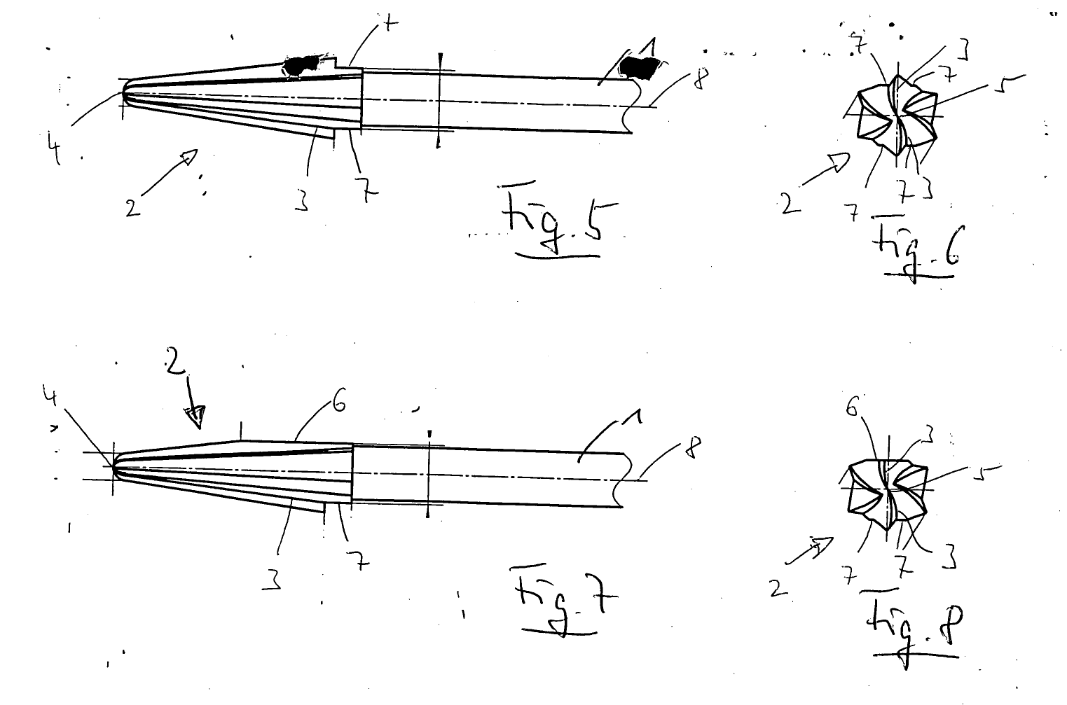

In an embodiment of the dental drill 10 shown in FIGS. 5 and 6, a pair of second axial marks 24 are formed, which are disposed more backwardly and define a substantially flat surface (the surface shown FIG. 6 being interrupted by the visible cutting edge 16). The flat surface is arranged substantially parallel with the rotary axis “A.” The second axial marks 24 start at a distance of, e.g., about 2.75 mm from the tip 18 of the head 14 and extend along a remaining length of the head 14 to the shaft 12. In an embodiment of the dental drill 10 shown in FIGS. 7 and 8, a first axial mark 22 and a second axial mark 24 are formed in combination with each other.

It should be appreciated by those having ordinary skill in the related art that each of the axial marks 22, 24 can have any suitable shape, size, and structure and structural relationship with each other, the shaft 12, the remainder of the head 14, and the rotary axis “A.” It should be so appreciated also that each of the axial marks 22, 24 can start at any suitable distance from the tip 18 of the head 14 and extend any suitable distance along the head 14.

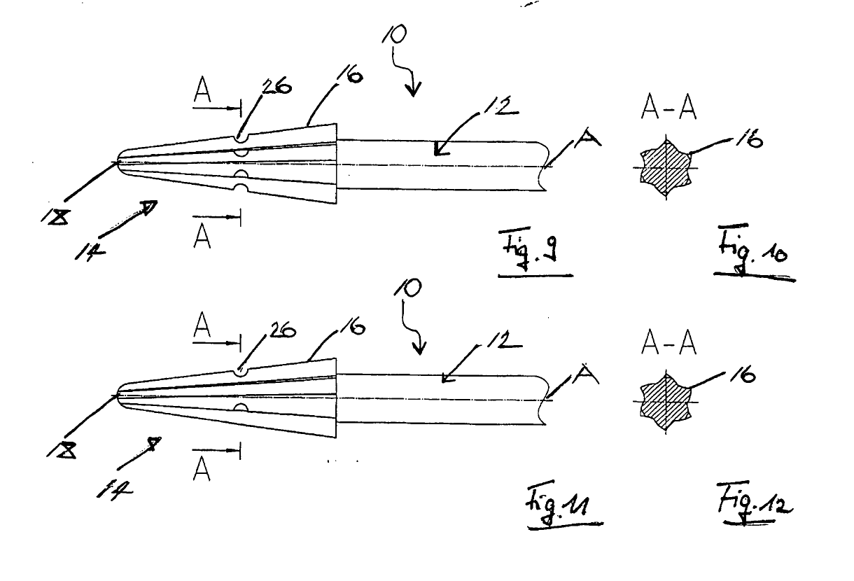

In an embodiment of the dental drill 10 shown in FIGS. 9 and 10, each cutting edge 16 is provided with a substantially semi-circular or semi-spherical notch 26 extending in an axial direction. The notches 26 are arranged like an annular groove in a plane defined substantially perpendicular to the rotary axis “A.”

A plurality of notches can be provided at one of the cutting edges 16 in an axial direction. Alternatively, a plurality of notches can be provided at a plurality of cutting edges 16 in the form of an annular groove. For example, in an embodiment of the dental drill 10 shown in FIGS. 11 and 12, three of six cutting edges 16 are provided with a notch 26, wherein the notches 26 are arranged in a plane defined perpendicular to the rotary axis “A.” The distance to the notches 26 from the tip 18 is, e.g., about 1.65 mm or 2.75 mm, dependent upon the overall dimensions of the dental tool 10. This distance may be to the axially front portion of the notch 26 or the middle plane of the notch 26.

It should be appreciated by those having ordinary skill in the related art that each notch 26 can have any suitable shape, size, and structure and structural relationship with each other, the shaft 12, the remainder of the head 14, and the rotary axis “A.” It should be so appreciated also that any suitable number of notches 26 can be provided at each of any suitable number of cutting edges 16. It should be so appreciated also that the distance to each notch 26 from the tip 18 can be any suitable distance.

In operation of the dental drill 10, a dentist treats a deeply decayed area of teeth. More specifically, using only the dental drill 10, the dentist determines exactly the operating depth of the dental drill 10 (even while the dental drill 10 rotates) and performs a complete treatment. In so doing, the dentist removes the decayed area as exactly as possible and simultaneously preserves the non-decayed tooth substance. The dentist then performs the same process for each of the other decayed areas of teeth.

Use of the dental drill 10 permits for an optimized treatment. More specifically, use of the dental drill 10 permits a relatively deep treatment to be performed completely such that exchange and use of further dental drills is not required to complete the treatment. Also, the dental drill 10 has a simple structure, can be manufactured in a simple and cost-effective manner, and is universally usable. Furthermore, use of the dental drill 10 permits an operating depth of the dental drill 10 to be recognized without any problem and the axial mark 22, 24 to be optically visible and clearly discernable during rotation of the dental drill 10. In addition, the dental drill 10 can be provided with more than one axial mark 22, 24 each of which clearly indicates an operating depth of the dental drill 10. Moreover, mechanical strength of the head 14 in not substantially affected, and the cutting portion(s) 16 permit(s) the operating depth of the dental drill 10 to be relatively greater to guarantee the treatment.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A dental drill comprising:
a shaft; and
a head extending from an end of the shaft, including at least one cutting edge, and defining a length of greater than about 2.5 mm.

2. The dental drill as set forth in claim 1, wherein said head defines a length of about 3.1 mm.

3. The dental drill as set forth in claim 1, wherein said head includes a plurality of cutting edges.

4. The dental drill as set forth in claim 1, wherein at least one axial mark is arranged at a portion of said head substantially facing said shaft.

5. The dental drill as set forth in claim 1, wherein said at least one axial mark is in the form of an oblate portion of said head.

6. The dental drill as set forth in claim 5, wherein said at least one axial mark defines a substantially flat surface.

7. The dental drill as set forth in claim 6, wherein said flat surface is arranged substantially parallel with a rotary axis.

8. The dental drill as set forth in claim 5, wherein a first of said at least one axial mark starts at a distance of about 1.65 mm from a tip of said head and extends along a remaining length of said head to said shaft.

9. The dental drill as set forth in claim 8, wherein a second of said at least one axial mark starts at a distance of about 2.75 mm from said tip of said head and extends along the remaining length of said head to said shaft.

10. The dental drill as set forth in claim 7, wherein a pair of axial marks are provided opposite to each other with respect to said rotary axis.

11. The dental drill as set forth in claim 1, wherein at least one of said plurality of cutting edges is provided with at least one notch.

12. The dental drill as set forth in claim 11, wherein said at least one notch is arranged in a plane defined substantially perpendicular to a rotary axis.

13. The dental drill as set forth in claim 11, wherein said at least one notch is arranged at a distance of about 1.65 mm from a tip of said head.

14. The dental drill as set forth in claim 11, wherein said at least one notch is arranged at a distance of about 2.75 mm from a tip of said head.

15. The dental drill as set forth in claim 11, wherein said at least one notch extends in an axial direction.

16. The dental drill as set forth in claim 11, wherein a plurality of notches are provided at one of said plurality of cutting edges in an axial direction.

17. The dental drill as set forth in claim 11, wherein a plurality of notches are provided at said plurality of cutting edges in the form of an annular groove.

18. The dental drill as set forth in claim 1, wherein said head is substantially conical.

19. The dental drill as set forth in claim 1, wherein said plurality of cutting edges are substantially straight.

20. The dental drill as set forth in claim 1, wherein said plurality of cutting edges are substantially helical.
